(19) United States
(12) Patent Application Publication
(10) Pub. No.: US 2006/0009993 A1
(43) Pub. Date: Jan. 12, 2006

(54) Method and structure for evaluation of long-term lease contracts under demand uncertainty

(75) Inventors: Xin Guo, Ithaca, NY (US); Tarun Kumar, Ossining, NY (US); Gyana R. Parija, Poughkeepsie, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/886,531

(22) Filed: Jul. 9, 2004

(51) Int. Cl. G06Q 99/00

(52) U.S. Cl. 705/1

(57) ABSTRACT

A method (and structure) of calculating an optimal mix of inputs for a problem having a plurality of possible scenarios, includes providing data for parameters for each of the scenarios, wherein the data includes a probability of each of the possible scenarios. A mix of parameters is determined for the problem by evaluating the plurality of scenarios, given the scenario probability inputs.

### BACKGROUND OF THE INVENTION

1. Field of the Invention

The present invention generally relates to stochastic programming modeling in scenarios having parameters for which there is uncertainty. More specifically, in an exemplary embodiment, each of several scenarios is entered either manually or via historical data mining, along with a probability estimate, and the computer tool will calculate a mix of input variables that will produce the optimal result, based on the probability entered. In a specific exemplary embodiment, the stochastic programming technique is demonstrated in a computer tool that calculates optimal result for lease contracts in a training environment

2. Description of the Related Art

In an exemplary environment used to discuss the technique of the present invention, the training organization of the assignee offers about 700 public classes nationwide every quarter and in a dozen U.S. cities. These classes are taught either by the assignee's training department (IBM Learning Services, hereinafter ILS) itself or by one of its training partners (TP).

The classes taught by ILS are held in classrooms that are located in facilities owned by another component of the assignee and leased to ILS for purpose of training, if the necessary classrooms are available. Otherwise, ILS teaches these classes in rooms procured from external vendors such as Nationwide and Microtec (on a daily rental basis) through short-term leases. Thus, if a TP provides the training service, then typically the TP will be responsible for providing instructors, classroom facilities, and other costs of the training.

The classrooms in the facilities owned by the assignee are procured through long-term leases (six to ten years) from the assignee's component that actually owns the property. When a lease comes up for renewal (for a period between six to ten years), ILS decision-makers have three options:
(i) Vacate the leased space and go to a TP;
(ii) Sign on to the exact same space (same number of rooms); and
(iii) Partition the space, if negotiable, for a different number of rooms.

If more rooms are needed than what is available, then the demand may be met by either going to a TP, or by going with a mix of resources available from the assignee in combination with the resources available from the spot market (Microtec, Nationwide).

A long-term lease results in predictable classroom availability at a relatively low marginal cost. However, the flip side is that these long-term leases incur a high fixed cost, which translates into a financial loss if/when the seat utilization is low. On the other hand, short-term leasing may be more expensive, but can provide a higher degree of flexibility in responding to demand fluctuations.

Therefore, depending on the demand and its level of uncertainty, it may be preferable to have a short-term lease instead of a long-term lease, keeping in mind that future demand projections may favor long-term leases versus short-term ones. Historically, ILS has adopted a simple “rule of thumb”’ planning method that was based on practical experience. This has resulted in documented low room utilization (51% for Atlanta in 2002) and poor revenue realization (negative growth in revenue).

The current business impetus to transform various of the assignee's business operations to be “On Demand Businesses” motivated ILS to terminate existing unprofitable long-term facility leases, and move to a variable cost structure. As a result, over the last year or so, ILS has terminated a few long-term leases at facilities in Atlanta, San Jose, Tampa, etc.

However, these exit decisions were taken in the absence of a scientifically robust lease evaluation tool. Hence, there remains a need for a tool to calculate an optimal mix of input parameters for various possible scenarios.

Therefore, as explained above, a need exists for a computerized tool that can accept inputs for a number of input parameters related to a number of potential scenarios and automatically calculates a mix of input parameter values that will maximize a specific goal, given a probability of each scenario.

### SUMMARY OF THE INVENTION

In view of the foregoing, and other, exemplary problems, drawbacks, and disadvantages of the conventional system, it is a an exemplary feature of the present invention to provide a computer tool that uses stochastic programming to provide an optimal mix of input parameters for a number of possible scenarios.

It is another exemplary feature of the present invention to provide a technique in which an estimated probability is entered as a parameter for each of the possible scenarios, thereby weighting the calculations for an optimal mix.

To achieve the above exemplary features and others, in a first exemplary aspect of the present invention, described herein is a methodof calculating an optimal mix of inputs for a problem having a plurality of possible scenarios, including providing data for parameters for each of the scenarios, wherein the data includes a probability of each possible scenario, and determining a mix of parameters for the problem by evaluating the plurality of scenarios, given the scenario probability inputs.

In a second exemplary aspect of the present invention, described herein is an apparatus for calculating a mix of inputs for a problem having a plurality of possible scenarios, the apparatus including at least one of a graphical user interface (GUI) to allow entry of data for parameters for each of the scenarios, wherein the data includes a probability of each possible scenario, a calculator for determining a mix of parameters for the problem by evaluating the plurality of scenarios, given the scenario probability inputs, and a GUI to permit at least one of displaying and printing a result of the calculator.

In a third exemplary aspect of the present invention, described herein is a user terminal, including a graphical user interface (GUI) to at least one of display and print a result of determining a mix of inputs for a problem having a plurality of possible scenarios by evaluating the plurality of scenarios, given a scenario probability for each scenario.

In a fourth exemplary aspect of the present invention, described herein is a signal-bearing medium tangibly embodying a program of machine-readable instructions executable by a digital processing apparatus to perform a method of calculating a mix of inputs for a problem having a plurality of possible scenarios, the program including at least one of a graphical user interface (GUI) module to allow entry of data for parameters for each scenario, wherein the data includes a probability of each possible scenario, a calculator module for determining a mix of parameters for the problem by simultaneously evaluating the plurality of scenarios, given the scenario probability inputs, and a GUI module to permit at least one of displaying and printing a result of the calculator.

Thus, the present invention provides a computer tool that uses stochastic programming to provide an optimal mix of input parameters for a number of possible scenarios that takes into account uncertainty, such as demand uncertainty or uncertainty caused by inherent variation due to sources of variation that elude control or due to the inconsistency of natural phenomena. Rather than treat this variability qualitatively, the present invention incorporates it into the mathematical model and, thus, handles it quantitatively.

### BRIEF DESCRIPTION OF THE DRAWINGS

The foregoing and other exemplary features, aspects and advantages will be better understood from the following detailed description of an exemplary embodiment of the invention with reference to the drawings, in which:

FIG. 1 illustrates an exemplary graphic user interface (GUI) display 100 for an Analysis Scope panel that allows entry of parameter values for the scenario of training, as used for explaining the present invention;

FIG. 2 illustrates an exemplary GUI display 200 for a Supplier panel for entry of supplier parameter values;

FIG. 3 illustrates an exemplary GUI display 300 for a Training Partner panel for entry of training partner parameter values;

FIG. 4 illustrates an exemplary GUI display 400 for a Demand panel for entry of demand parameter values;

FIG. 5 illustrates an exemplary GUI display 500 for the Optimization panel for instructing the computer tool to evaluate optimum values;

FIG. 6 illustrates an exemplary GUI display 600 for the Results panel that displays the optimum values calculated by the exemplary tool of the present invention;

FIG. 7 illustrates an exemplary flowchart 700 for a generalized method of the present invention;

FIG. 8 illustrates an exemplary block diagram 800 of a generalized computer tool to execute the method shown in FIG. 7;

FIG. 9 illustrates an exemplary hardware/information handling system 900 for incorporating the present invention therein; and

FIG. 10 illustrates a signal bearing medium 1000 (e.g., storage medium) for storing steps of a program of a method according to the present invention.

### DETAILED DESCRIPTION OF A PREFERRED EMBODIMENT OF THE INVENTION

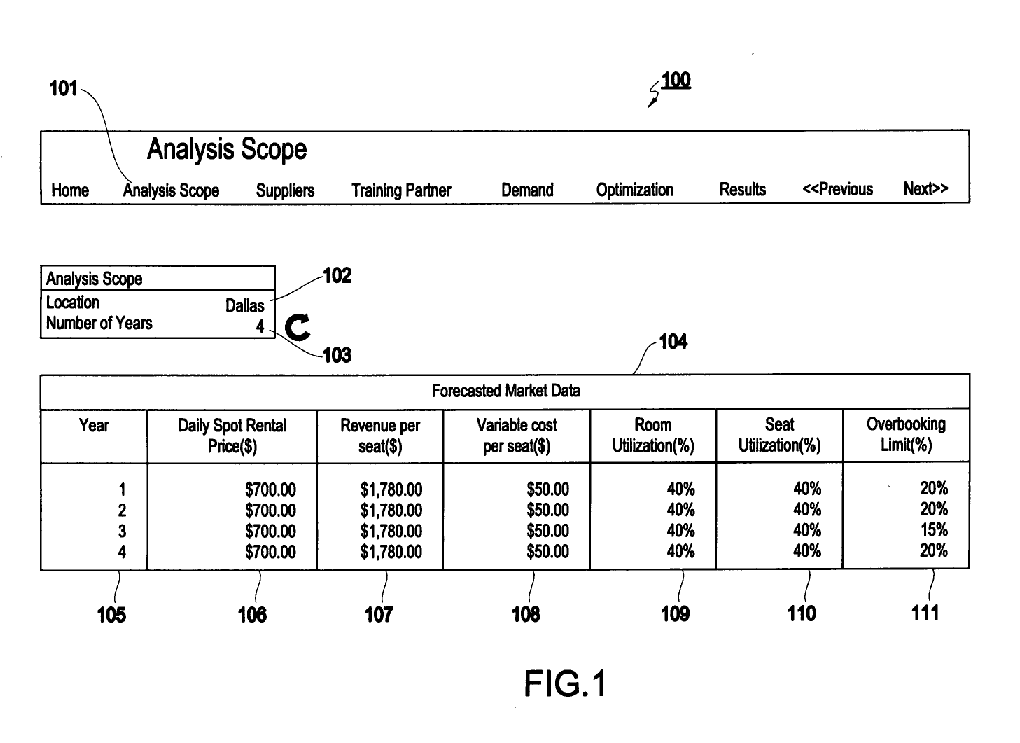

Referring now to the drawings, and more particularly to FIGS. 1-10, an exemplary embodiment of the present invention involving leasing decisions will now be described.

It is noted that one of ordinary skill in the art, after having read the details described herein, would readily be able to apply the present invention as appropriate for any number of other problems in which a probability can be estimated for various scenarios and specific input parameters can be entered for each of these scenarios.

Thus, provided herein is an innovative, stochastic programming optimization technique and computer tool that enables an optimization analysis under different scenarios.

In an exemplary embodiment of the present invention, a computer tool is specifically designed for ILS decision-makers for analyzing complex leasing options very quickly and for providing sound justification for the optimal leasing decisions.

The development of the present invention led the inventors to recognize that a need exists in modeling for a computer tool that will calculate an optimal mix of input parameters for various possible scenarios, given an estimate of possibility for each scenarios or input parameters for that scenario.

It was also readily recognized that this tool had potential in any environment in which a probability can be ascertained for the scenario and/or the input parameters for various projected scenarios. Hence, the concept of this specific tool application discussed hereinbelow is easily extended to other scenarios. As non-limiting examples, possible other scenarios for which the stochastic programming approach of the present invention could find application include weather forecasting, financial asset pricing, insurance, risk management, and inventory forecasting.

A key feature of the present invention, as exemplarily embodied for the training environment, is that it provides a stochastic programming optimization technique for simultaneously evaluating multiple scenarios. In contrast, the conventional techniques are based on deterministic models that subsequently incorporate linear programming for optimization.

The present inventors have recognized that the stochastic programming technique discussed hereinbelow provides a more simple and efficient technique that includes probability at the core of the modeling, thereby improving accuracy and robustness. The present invention provides a stochastic integer programming model for evaluation of long term lease contracts under demand uncertainty. For the exemplary classroom leasing problem, this model evaluates multiple scenarios corresponding to random demands for classrooms and maximizes the expected revenue (e.g., profit). The system also proposes a combination of long term and short term leases to minimize the risks and maximize the revenue (e.g., profit).

More specifically, in the exemplary training scenario, the present invention provides a stochastic programming-based, constrained optimization technique and analytical tool that enables analysis between students' demand uncertainty and revenue/profit trade-offs, under different operational scenarios such as over-booking of classrooms and early lease terminations of long-term leases of training facilities.

The present invention allows the description and input of a two-stage tree of user-defined demand scenarios and corresponding lease options, both long term and short term, available for optimizing the mix of leases. The revenue/profit optimization model corresponds to a two-stage mixed integer program that can be resolved using any commercial off-the-shelf MIP (Mixed-Integer Programming) solver. A mixed-integer programming problem is a problem in which some of the decision variables are constrained to have only integer values.

FIG. 1 shows a first data entry window 100 (Analysis Scope window) of an exemplary graphic user interface (GUI) that has been developed as part of the computer tool embodying the exemplary embodiment of the present innvention.

To begin, it is first noted that the toolbar menu 101 at the top provides access to each of the various windows to be discussed below, including this first Analysis Scope window 100.

In the exemplary scenario, the user of the present invention might typically be a marketing or business analyst in the training division who has been assigned the task of determining an optimal mix of parameters. However, it is noted that one of ordinary skill in the art would readily recognize, after taking the discussion herein as a whole, that the concepts of the training scenario could easily be expanded into other scenarios by making changes in the parameters to be entered and the equations that would be appropriate for modeling another scenario.

As shown in FIG. 1, the Analysis Scope window 100 allows the user to enter parameters related to the lease evaluation. More specifically, the user in the exemplary scenario has entered the location 102 as being Dallas and the term of evaluation 103 as being four years. Obviously, other locations and lease terms could be interactively selected.

The user has also entered the predicted values for Forecasted Market Data 104 for each of the four years 105, as follows:
Daily Spot Rental Price 106;
Revenue per seat 107;
Variable cost per seat 108;
Room Utilization 109;
Seat Utilization 110; and
Overbooking Limit 111.

These values may be derived from predicted marketing analysis or from historical data, and it should be apparent to one of ordinary skill in the art that these parameters will vary depending upon the scenario for which the present invention is being used.

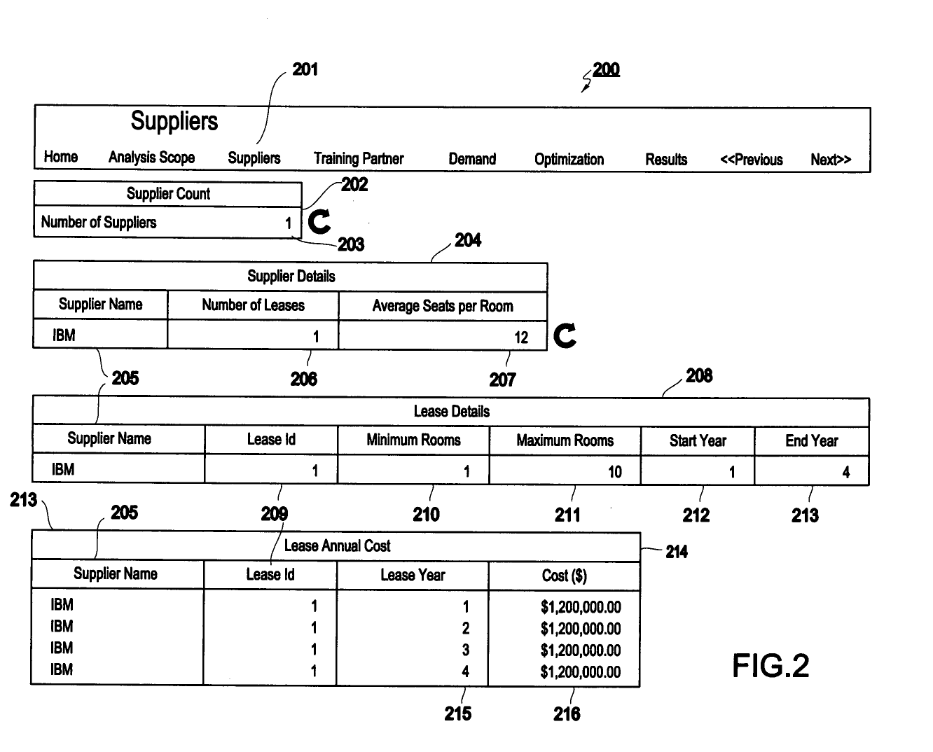

In the next panel 200 shown in FIG. 2, accessed via the toolbar at the top of the screen by selecting the “Suppliers” tab 201, the user will then enter values for parameters for potential suppliers of the training, as follows:
Number of suppliers 202 (in the example, there is only one supplier 203);
Supplier details 204, including supplier name(s) 205 and the number of leases 206 and average seats per room 207 for each supplier;
Lease details 208, including, for each supplier 205, the lease identification 209, minimum number of rooms 210, maximum number of rooms 211, and starting year 212 and ending year 213; and
Lease annual cost 214, including the annual cost for the lease 216 for each supplier 205 and for each year 215.

It should be noted that the tool will automatically fill in various entries, such as supplier name 205, lease ID 209 and lease year 215, once these entries have been filled in for a first time in an earlier entry.

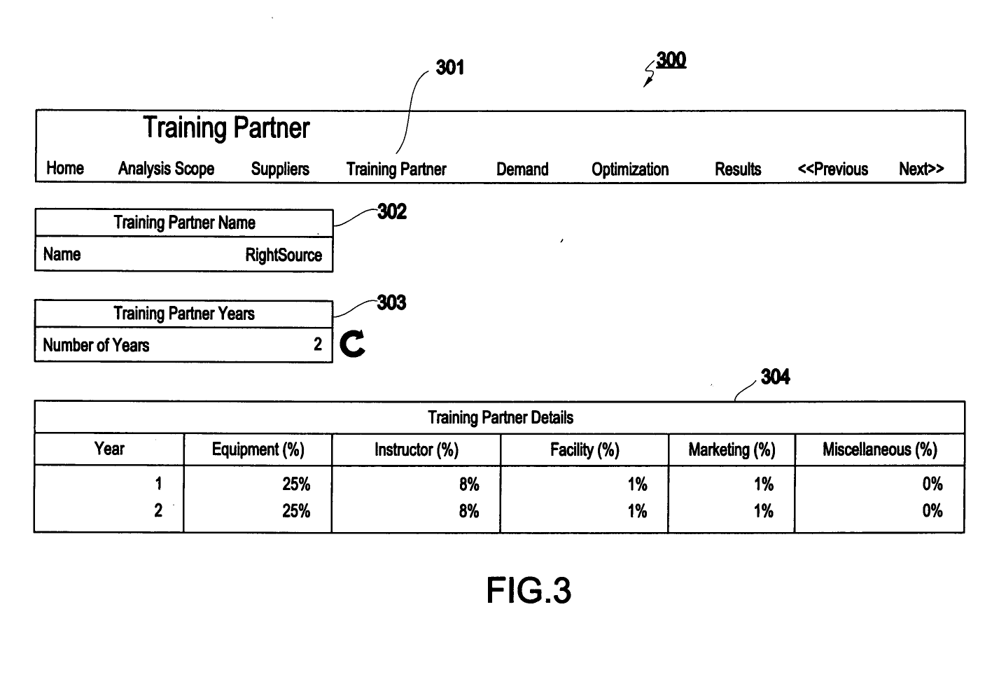

FIG. 3 illustrates the Training Partner panel 300, accessed via the toolbar “Training Partner” tab 301 at the top of the screen, for entry of parameters, including:
Training Partner name 302;
Number of years 303; and
Details 304.

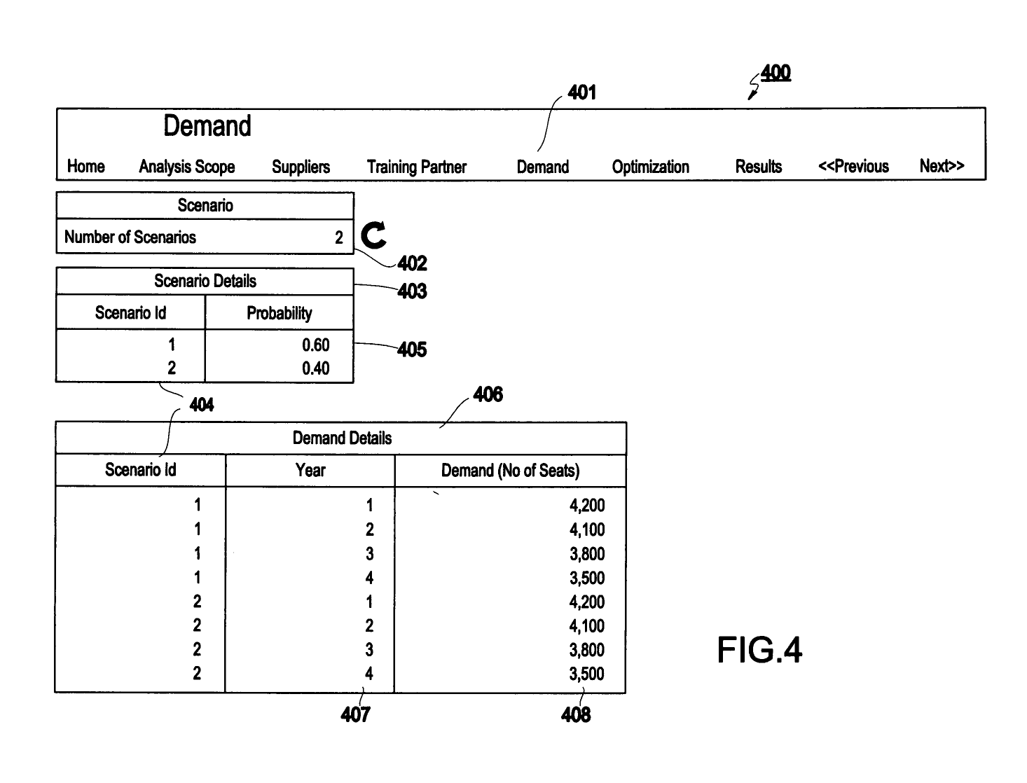

FIG. 4 illustrates the Demand panel 400, accessed via “Demand” tab 401, for entry of Demand parameters, including:
Number of scenarios 402;
Scenario details 403, including the scenario identification 404 and probability 405 for each scenario; and
Demand details 406, including the predicted seat demand 408 for each year 407 and scenario 404.

It is noted that the probability 405 (either alone or with other criteria) for each demand scenario 404 is the entry that enables the present invention to function as a stochastic programming technique, in contrast to the conventional deterministic techniques.

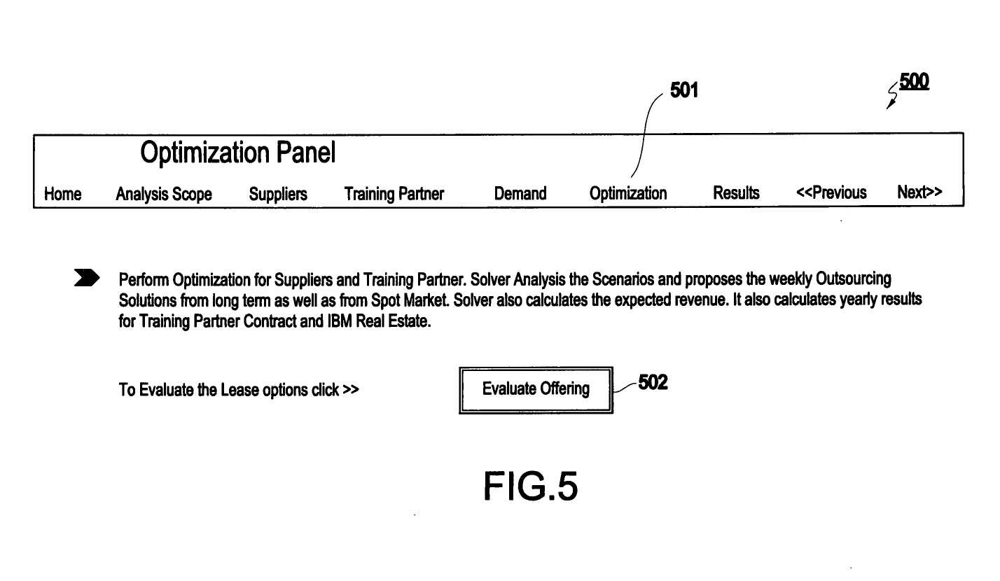

FIG. 5 illustrates the Optimization Panel 500, accessed via tab 501, which provides the selector 502 to command the tool to perform the optimization for the scenarios for which parameter data has been entered.

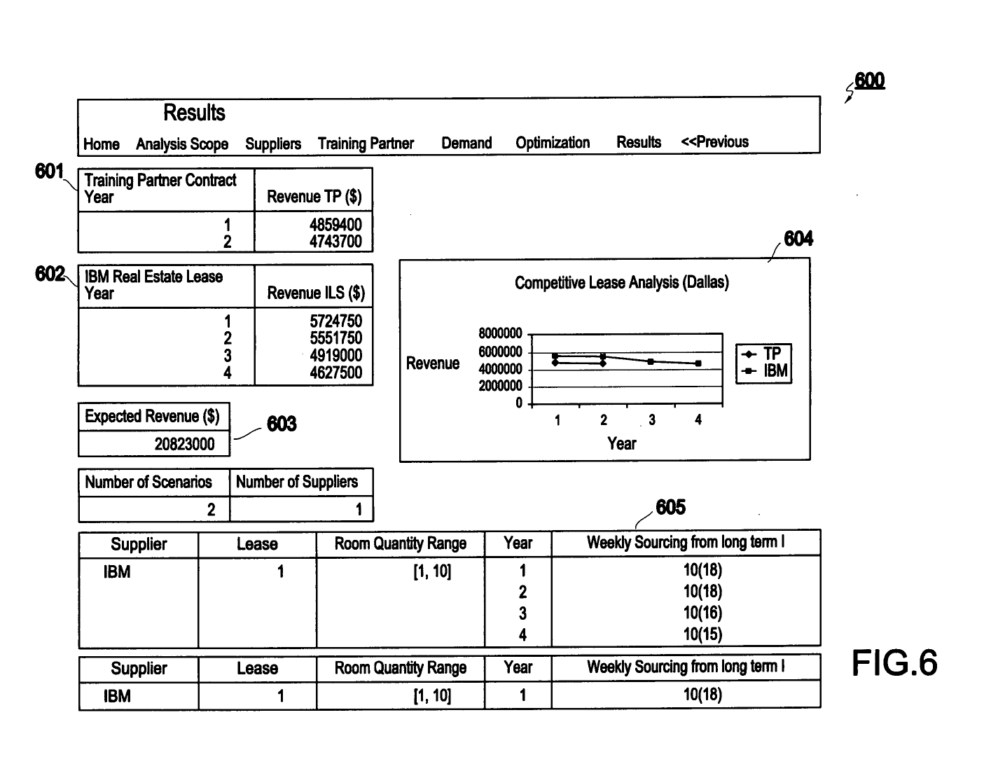

FIG. 6 illustrates the Results panel 600 for the parameters entered in FIGS. 1-4, including the projected revenues for the TP 601, for the assignees holding company 602, expected revenues 603, and a yearly graph 604. In this exemplary case, the optimum occurs if 10 rooms are arranged on a long term lease (605).

The optimization method is now described below for the exemplary scenario of training. It should be apparent to one of ordinary skill in the art, after taking the present discussion as a whole, that corresponding equations would apply in other scenarios.

Analysis of the Training Scenario in the Assignee's Owned Facilities

In this training scenario, the gross revenue for using the present Assignee's owned facilities is determined by the number of student (denoted by S′). If the average payment R from each student is known, then the gross revenue can be approximated by R*S′. Using the present Assignee's own facility renders fixed cost (equipment, facility, depreciation, and some stuff payment) C₁, together with some variable cost C₂ which is related to the number of actual student enrollment.

Thus, the profit margin can be estimated, based on assuming the following input:

S(s,t), estimated number of student enrollment (under demand scenario ‘s’) for each period (t, t+1);
S′(t), Actual enrollment for period (t, t+1);
C₁(t), Fixed cost (facility, equipement) for period (t, t+1);
R(t), Average revenue from each student for period (t, t+1);
p(s), Probability of occurrence of scenario s;
C₂(S′(t)), Variable cost as a function of student number for period (t, t+1); and
U(s,t), the classroom utilization under scenario s. It is noted that S(s,t) and S′(t) are associated with S(s,t)U(s,t)=S′(t).

The profit on the present Assignee's owned facilities is given by:
P(own)=Σ(s)p(s)Σ(t)(R(t)*S′(t)−C₁(t)−C₂(S(s,t)).
Analysis of Training in the Leased Facilities

Assuming the revenue (or the student enrollment) and the variable cost for leasing facility remains the same as in the case of the present Assignee's own facilities, the major different in cost, in comparison to the present Assignee's owned facilities, is the long term lease payment cost, plus some fixed cost C₁′ excluding the cost of facility. It is assumed that each lease of ILS is with fixed term on leasing cost and duration. The best profit margin would come with the best arrangement of different lease contract.

For example, if in 2002, there are estimations of 3000, 4000, 4500, 5000 students in each quarter, and there are options of signing two different leases with different capacities of 500, 600 students, with lease term 3 months and 6 months, what is the best possible arrangement for signing the lease? How many and which one? Using the present invention, such can be optimally determined.

Assuming that each classroom configuration is known in advance, then the required classroom number W(t) can be obtained knowing the number of students. Thus, the profit margin can be evaluated via solving some IP (Integer Program) problems with the assumption of the inputs identified below. An integer programming problem is one in which all variables are required to be integer. The mathematical model for integer programming is simply the linear programming model with one additional restriction that the variables must have integer values.

The profit margin inputs are:
S(t), estimated number of the student enrollment for each period (t, t+1);
S′(t), actual enrollment for period (t, t+1);
C₁′(t), fixed cost for period (t, t+1);

R(t), average revenue from each student for period (t, t+1);
C₂(S′(t)), variable cost as a function of student number for period (t, t+1);
W(t), the required number of classroom units;
All available types of lease;
Cost of each lease; and
Duration of each lease.

For example, assuming two different types of leasing, A and B, and 1(1) is the lease payment per classroom unit per day for A which lasts for 6 months, and 1(2) is a leasing cost for B of 12 months contract. Here it is assumed that 1(1)>1(2), namely the longer the lease, the cheaper the cost. If 1(1)<1(2), then in general one would go for the cheaper and shorter one.

To estimate the cost of leasing is to find the optimal number a(t) for lease type 1 and b(t) for lease type 2, which is to approximate of the following IP problems related to profit of leasing:
P(leasing)=Maximize {S(t)R*S′(t)−C₁′−C₂(S(t))−(a(t)*1(1)−b(t)*1(2))},
subject to: a(t)+b(t)−b(t−1)≧W(t), a(t), b(t)εN.

The above algorithms can be modified in case there is any need to accommodate some non-linear payment in the lease due to interest rate change or depreciation factors. For example, a(t)*1(1) can be replaced by f₁(a(t)) for the cost of lease contract A.

One of the advantages of leasing is to cope with uncertainty in the market demand, with higher flexibility. Therefore, estimation of profit margin may be more accurate with the incorporation of the uncertainty of student number. If overbooking (μ) is allowed, then the profit margin can be evaluated via the following alternative:
P(leasing)=Maximize ∫R*S′(t)−C1−f₁(a(t))−f₂(b(t))dt,
Subject to: a(t)+b(t)−b(t−1)−W(t)<μ.

The advantage of this formulation is that it does not require the exact knowledge of future demand distribution, yet near optimal solution can be solved via mere estimation of the average student number and the variance, which can be estimated by some historical data. Moreover, it allows the possible input of penalty cost for early termination of a lease contract.

Working with the TP

Since the present Assignee pays a fraction of its gross revenue to its TP, the actual revenue will be the gross margin less the part paid to the TP. The major cost comes from its payment to instructors on the basis of teaching days. Thus, estimation of the profit margin from TP is determined by the following factors:
S(t), average number of the student enrollment for each period (t, t+1);
S′(t), actual enrollment for period (t, t+1);
R(t), average revenue from each student for period (t, t+1);
A, the average revenue percentage remaining after paying to TP;
P, Average pay to instructor per teaching day; and
D, Average teaching day.

Given these above-identified factors, the profit for working with the TP is:
P(TP)=Σ(t)R*E(S′(t))*A(t)−P(t)*D(t).
Decision Rules

Once the estimation of P(TP), P(leasing), and P(own) have been obtained, it is possible to make decisions on the three options. For example, if the profit P(TP)>max(P(leasing), P(own)), then working with TP is a favorable choice. Otherwise, P(TP)<max(P(leasing), P(own)), then TP is not a favorite option and it is further compared if P(leasing)>P(own), to see if leasing is a better choice.

Of course, it is possible that all three options give comparable results based on the frame work provided above. In that case, it would be necessary to look beyond some of the major factors, and include some more detailed or even intangible factors to determine an optimal. These comparisons and the intangible factors can be evaluated by the user or incorporated into the computer tool.

While the current invention disclosure evaluates lease options from one supplier (e.g., IBM Real Estate) offering just one product (Rooms) in the face of demand uncertainty, this invention can address the broader problem of evaluating sourcing contracts involving multiple suppliers with multiple products portfolios faced with uncertainty in demands and prices of products, such as the following non-limiting examples illustrate.

Airline Portfolio Management

The objective of the portfolio management optimization is to maximize the return on invested capital by selecting an optimal mix of stocks and bonds. For example, taking a case of transportation stocks, historical data can be used to create drives (positive and negative) for the transportation stock. Further, in order to be able to accurately forecast the portfolio value, a scenario-based optimization model can be used to capture the variability in the drivers of the stock prices. This variability can be captured and brought into the model using stochastic programming modeling as discussed above for the classroom leasing scenario.

Electricty Power Generation Planning

Electric power generation planning is based on the forecasted requirement in near term (e.g., for a one-week cycle). This requirement is subject to variability and has drivers that increase/decrease the power requirements. For example, extreme weather conditions will spike up the requirement for power while a moderate or pleasant weather forecast will substantially reduce the requirement. Using a scenario-based optimization, a modeler is able to bring in the invariability into the mathematical model instead of handling it outside the model.

Another application would be the determination of the optimal mix of contracts to meet the demand for a multitude of commodities, while capturing demand and price uncertainty. The contracts might include options, outright sales, and bellman's conditional sales.

Conventional techniques do not take into account the demand uncertainty. This uncertainty is caused by inherent variation due to sources of variation that elude control or due to the inconsistency of natural phenomena. Rather than treat this variability qualitatively, the present invention incorporates it into the mathematical model and, thus, handles it quantitatively.

This treatment generally can be accomplished if the natural phenomena exhibit some degree of regularity, so that their variation can be designed by a probability model. The present invention handles the variability (uncertainty) in the demand by using stochastic programming technique that allows one to specify the demand scenario and probability for each of the scenarios.

Other non-limiting examples of real-life scenarios for which the stochastic programming technique of the present invention might be adapted for modeling and optimization include weather forecasting, financial asset pricing, insurance, risk management, and inventory forecasting.

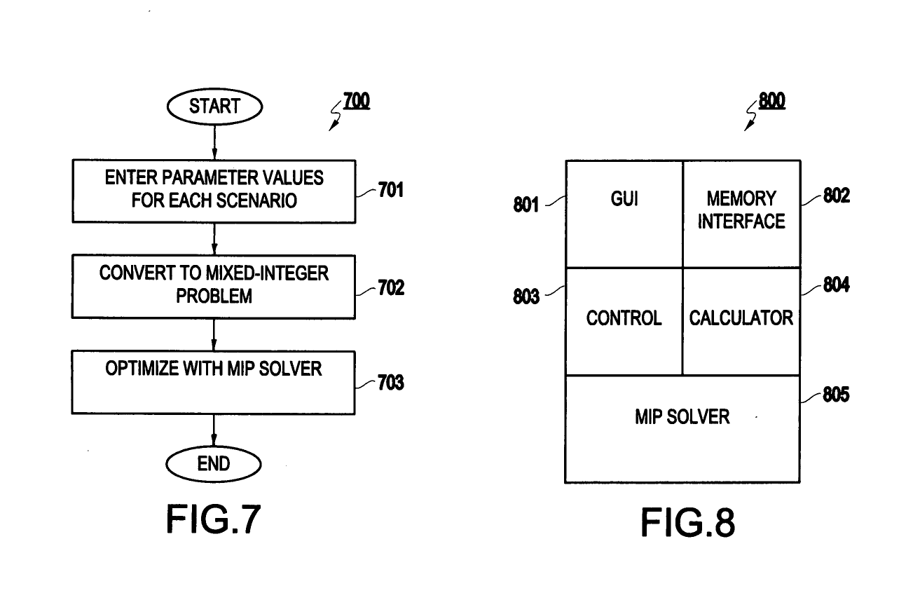

FIG. 7 illustrates an exemplary flowchart 700 of the present invention as showing the steps discussed above, but as also describing a more generalized technique for optimizing a result for n mutually exclusive scenarios {Sᵢ, i=1, . . . , n}, with each scenario Sᵢ, having a probability of occurrence pᵢ. One or more parameters in the model may also have an associated indication of probability, as expressed by, for example, a value entered for a variance of that parameter. The computer tool is presumed to include one or more equations appropriate to model the cost function(s) associated with each scenario Sᵢ, corresponding to the equations identified above for the leasing problem.

In step 701, model parameter values are entered into the computer tool for each scenario Sᵢ, including scenario probability of occurrence pᵢ. The parameters for the leasing scenario were discussed above, but it can be readily appreciated that other modeling problems require parameters appropriate for those problems, as well as modeling equations for each problem.

In step 702, the computer tool fits these data entries into a two-stage mixed integer program that is resolved in step 703 by any MIP solver. Development of the tool requires that the cost/benefit function(s) appropriate for each scenario be pre-programmed into the tool for the problem being addressed, similar to the equations discussed above for the classroom leasing problem.

FIG. 8 exemplarily illustrates a block diagram 800 for the computer tool. Graphical user interface (GUI) 801 allow a user to interact with the tool to control operation and entry of data. The data could be entered by the user through the GUI 801 or, as mentioned above, could be data resultant from a data mining operation outside the present invention, which data mining results are stored in a document for entry into the tool by entry commands of the user via the GUI 801.

Typically, the GUI 801 would also include interface with a display device for viewing the operational steps involved in setting up the problem and for viewing the results of the calculations, as illustrated in FIGS. 1-6 for the leasing problem implementation of the present invention.

Memory interface 802 allows data to be retrieved and stored from a memory device. Control module 803 is a higher-level software module that controls the overall operation of the tool to properly invoke lower-level modules to, for example, allow data entry and display the entered data and to allow the calculations to proceed once an execute command is entered by the user.

Calculation module 804 allows the calculations to proceed in accordance with the modelling equations. Calculation module 804 might include a MIP solver as an integrated software module or, alternatively, as mentioned above, a separate MIP solver 805 might be invoked by the calculation module 804.

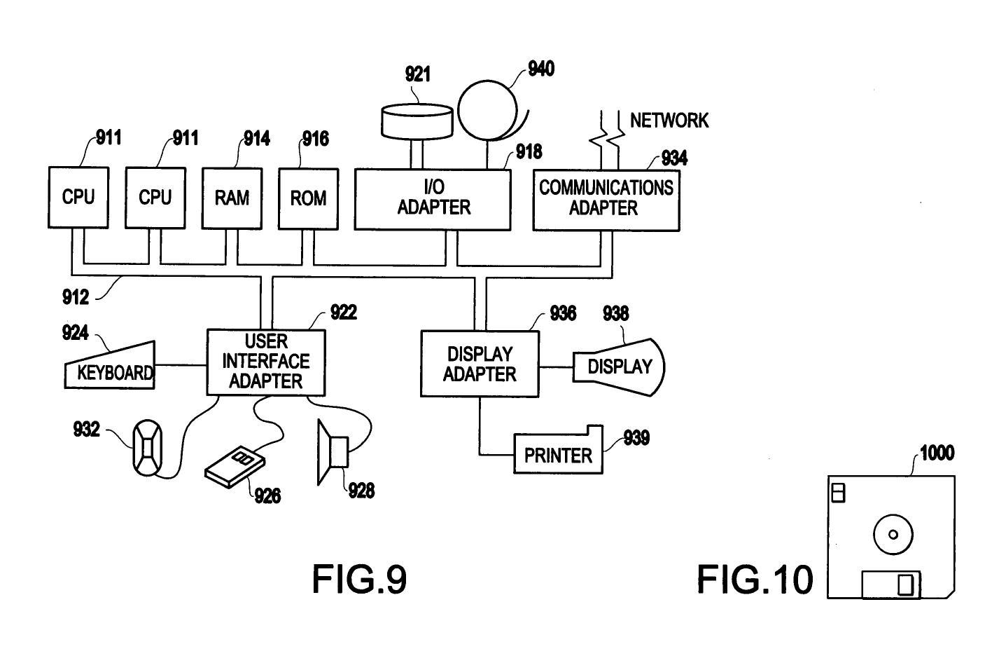

FIG. 9 illustrates a typical hardware configuration of an information handling/computer system in accordance with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 911 and hardware above, to perform the method of the invention.

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

In yet another aspect of the present invention, it should be readily recognized by one of ordinary skill in the art, after taking the present discussion as a whole, that the present invention can serve as a basis for a number of business or service activities. All of these potential service-related activities are intended as being covered by the present invention.

Thus, for example, the computer tool taught herein could readily be used as the basis for a consulting service, in which a business or service is set up to provide an optimum result as based on parameters provided by a client. This consulting service may interconnect to clients via a network such as the Internet.

In one possible exemplary embodiment using the Internet, a user could view the results of an optimization calculation on a user terminal. The user may or may not have entered the data used in the calculations. Moreover, the calculations may or may not have been executed by the user terminal.

That is, it is possible that the user downloads from a server a software module that will be used as the tool and the user then enters data for the calculations. But, it is also possible that the user controls the entry of data from other sources, such as remote databases, or that the user controls the execution of the tool, located at another terminal, via the user terminal.

The present invention would also lend itself to a service in which the consultation would include the search of historical data or other marketing prediction techniques to thereby provide consultation wherein the client merely provides a problem and/or data related to the problem, and the consultant would provide the service of determining the parameters to be entered as well as the optimum results.

In yet another service possibility for the present invention, a service could be based upon extending the stochastic programming technique of the present invention into other scenarios than the teaching scenario described above. In this aspect of the present invention, a consulting service would extend the stochastic programming computer tool for the training scenario for other applications.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described our invention, what we claim as new and desire to secure by Letters Patent is as follows:

1. A method of calculating an optimal mix of parameter inputs for a problem having a plurality of possible scenarios, said method comprising:
providing data for parameters for at least one said scenario, wherein said data includes a probability of said at least one scenario; and
determining a mix of said input parameters for said problem by evaluating said plurality of scenarios, given said scenario probability inputs.

2. The method of claim 1, wherein said data captures a demand and price uncertainty of said problem.

3. The method of claim 1, wherein said determining a mix comprises:
using said data to generate a mixed-integer programming problem that models said problem; and
solving said mixed-integer programming problem.

4. The method of claim 1, wherein said mixed-integer programming problem comprises at least one benefit/cost function that models said scenarios.

5. The method of claim 1, wherein said problem comprises determining a mix of classroom leases that captures a demand and price uncertainty.

6. The method of claim 1, wherein said problem comprises determining a mix of contracts to meet a demand for at least one commodity that captures a demand and price uncertainty.

7. An apparatus for calculating a mix of inputs for a problem having a plurality of possible scenarios, said apparatus comprising at least one of:
a graphical user interface (GUI) to allow entry of data for parameters for said scenarios, wherein said data includes a probability of each said possible scenario;
a calculator for determining a mix of parameters for said problem by evaluating said plurality of scenarios, given said scenario probability inputs; and
a GUI to permit at least one of displaying and printing out of a result of a calculator for determining an optimal mix of parameters for said problem by evaluating said plurality of scenarios, given said scenario probability inputs.

8. The apparatus of claim 7, wherein said calculator generates a mixed-integer programming problem from said data that models said problem.

9. The apparatus of claim 8, wherein said calculator further comprises:
a mixed-integer programming problem (MIP) solver to solve said mixed-integer programming problem.

10. The apparatus of claim 7, wherein said problem comprises determining an optimal mix of classroom leases that captures a demand and price uncertainty.

11. A user terminal, comprising:
a graphical user interface (GUI) to at least one of display and print a result of determining a mix of inputs for a problem having a plurality of possible scenarios by evaluating said plurality of scenarios, given a scenario probability for each said scenario.

12. The user terminal of claim 11, wherein said GUI further permits at least one of:
an entry of data for parameters for said scenarios, including said probability of each said possible scenario; and
control of a calculator for determining a mix of parameters for said problem.

13. The user terminal of claim 11, wherein said problem comprises one of:
determining an optimal mix of classroom leases that captures a demand and price uncertainty; and
determining an optimal mix of contracts to meet a demand for at least one commodity that captures a demand and price uncertainty.

14. A signal-bearing medium tangibly embodying a program of machine-readable instructions executable by a digital processing apparatus to perform a method of calculating a mix of inputs for a problem having a plurality of possible scenarios, said program comprising at least one of:
a graphical user interface (GUI) module to allow entry of data for parameters for each said scenario, wherein said data includes a probability of each said possible scenario;
a calculator module for determining a mix of parameters for said problem by evaluating said plurality of scenarios, given said scenario probability inputs; and
a GUI module to permit at least one of displaying and printing out of a result of a calculator module for determining a mix of parameters for said problem by evaluating said plurality of scenarios, given said scenario probability inputs.

15. The signal-bearing medium of claim 14, wherein said calculator module generates a mixed-integer programming problem from said data that models said problem.

16. The signal-bearing medium of claim 15, wherein said calculator module further comprises:
a mixed-integer programming problem (MIP) solver to solve said mixed-integer programming problem.

17. The signal-bearing medium of claim 14, wherein said problem comprises one of:
determining an optimal mix of classroom leases that captures a demand and price uncertainty; and
determining an optimal mix of contracts to meet a demand for at least one commodity that captures a demand and price uncertainty.

18. An apparatus for calculating an optimal mix of inputs for a problem having a plurality of possible scenarios, said apparatus comprising at least one of:
means for allowing entry of data for parameters for each said scenario, wherein said data includes a probability of each said possible scenario;
means for determining a mix of parameters for said problem by evaluating said plurality of scenarios, given said scenario probability inputs; and
means for at least one of displaying and printing a result of a calculator for determining a mix of parameters for said problem by evaluating said plurality of scenarios, given said scenario probability inputs.

19. The method of claim 1, wherein said evaluating said plurality of scenarios is achieved by representing said plurality of scenarios together in a common model.

20. A method of providing a consulting service that determines an optimal mix of inputs for a problem having a plurality of possible scenarios, said method comprising:
loading data for parameters for each said scenario, wherein said data includes a probability of each said possible scenario; and
using a calculator module for determining a mix of parameters for said problem by evaluating said plurality of scenarios, given said scenario probability inputs.
